(19) United States
(12) Patent Application Publication
(10) Pub. No.: US 2008/0056635 A1
(43) Pub. Date: Mar. 6, 2008

(54) Bottom bracket assembly for bicycles

(76) Inventor: Chien Hao Lee, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/511,241

(22) Filed: Aug. 29, 2006

(51) Int. Cl. F16C 13/00

(52) U.S. Cl. 384/545

(57) ABSTRACT

A bottom bracket assembly for bicycles includes a bottom bracket having two open ends and each open end has a first tapered inner periphery. Two bearings are respectively engaged with the two open ends and each bearing has a first tapered outer periphery so as to be engaged with the first tapered inner periphery of the bottom bracket. Each bearing has a central hole which has a second tapered inner periphery. An axle extends through the two bearings and has two connection ends which are connected with two cranks. Two positioning members are mounted to the axle and have a second tapered outer periphery which is engaged with the second tapered inner periphery of the bearing corresponding thereto.

### FIELD OF THE INVENTION

The present invention relates to a bottom bracket assembly for bicycles and the assembly includes less number of parts and is easily to be assembled.

### BACKGROUND OF THE INVENTION

A conventional bicycle bottom bracket assembly 80 is shown in FIGS. 5 and 6, and generally includes a bottom bracket 81 with two bearing units 83 connected to two ends thereof and an axle 82 extends through the bottom bracket 81 and is cooperated with the two bearing units 83. Each of the two bearing units 83 includes a bowl 832, a plurality of beads 831 received in the bowl 832 and a locking member 84 which connected to the bowl 832 and guides the movement path of the beads 831. The bowl 832 is engaged with each of two open ends of the bottom bracket 81 and the locking member 84 is threadedly mounted to the axle 82 and connected to the bowl 832 corresponding thereto. Two locking disks are then threadedly mounted to each one of two ends of the axle 82 to position the locking members 84. The accuracy of manufacturing of the parts and the assembling of the bottom bracket assembly decide the rotation of the axle 92 so that, in stead of the manufacturing processes of the parts, the quality of the assembling is crucial for the bottom bracket assembly. The requirements of assembling steps often consume a lot of time when assembling the conventional bottom bracket assembly.

The present invention intends to provide a bicycle bottom bracket assembly which is easily to be assembled and the precision of the assembling can be obtained by engagement between tapered surfaces of the parts of the bottom bracket assembly.

### SUMMARY OF THE INVENTION

The present invention relates to a bicycle bottom bracket assembly which comprises a bottom bracket having two bearings respectively engaged with the two open ends. Each open end has a first tapered inner periphery and each bearing has a first tapered outer periphery which is engaged with the first tapered inner periphery of the bottom bracket. Each bearing has a central hole which has a second tapered inner periphery and an axle extends through the two passages of the two bearings. The axle has two connection ends. Two positioning members are mounted to the axle and each have a second tapered outer periphery which is engaged with the second tapered inner periphery of the bearing corresponding thereto.

The object of the present invention is to provide a bottom bracket assembly that includes less number of parts and can be assembled easily.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the bottom bracket assembly of the present invention;

FIG. 2 is an exploded view to show the bottom bracket assembly of the present invention;

FIG. 3 is a cross sectional view of the bottom bracket assembly of the present invention;

FIG. 4 is a cross sectional view of another embodiment of the bottom bracket assembly of the present invention;

FIG. 5 is an exploded view to show a conventional bottom bracket assembly, and

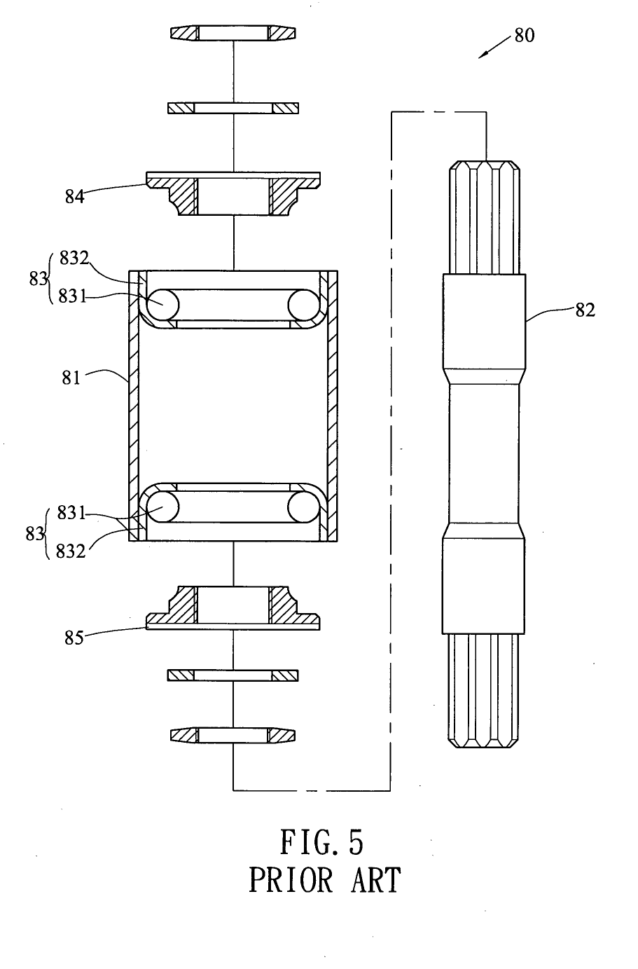

FIG. 6 is a cross sectional view to show the conventional bottom bracket assembly in FIG. 5.

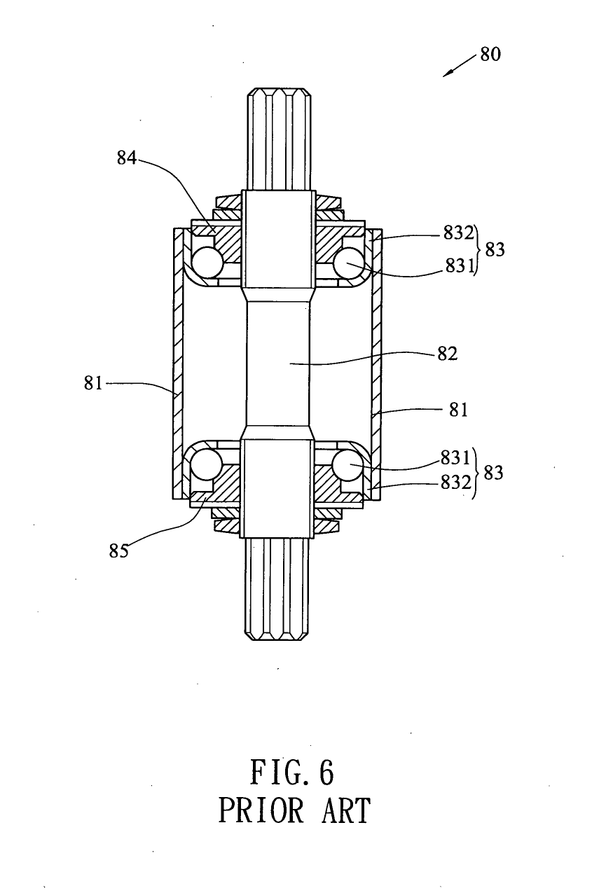

### DETAILED DESCRIPTION OF THE PREFERRED EMBODIMENT

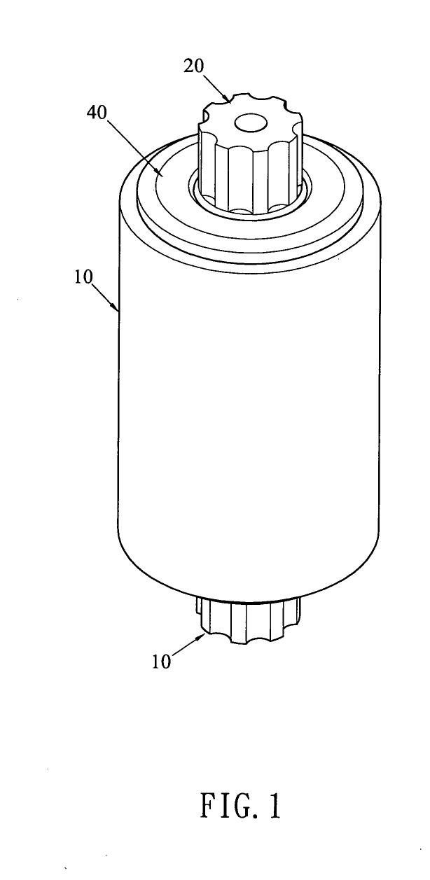

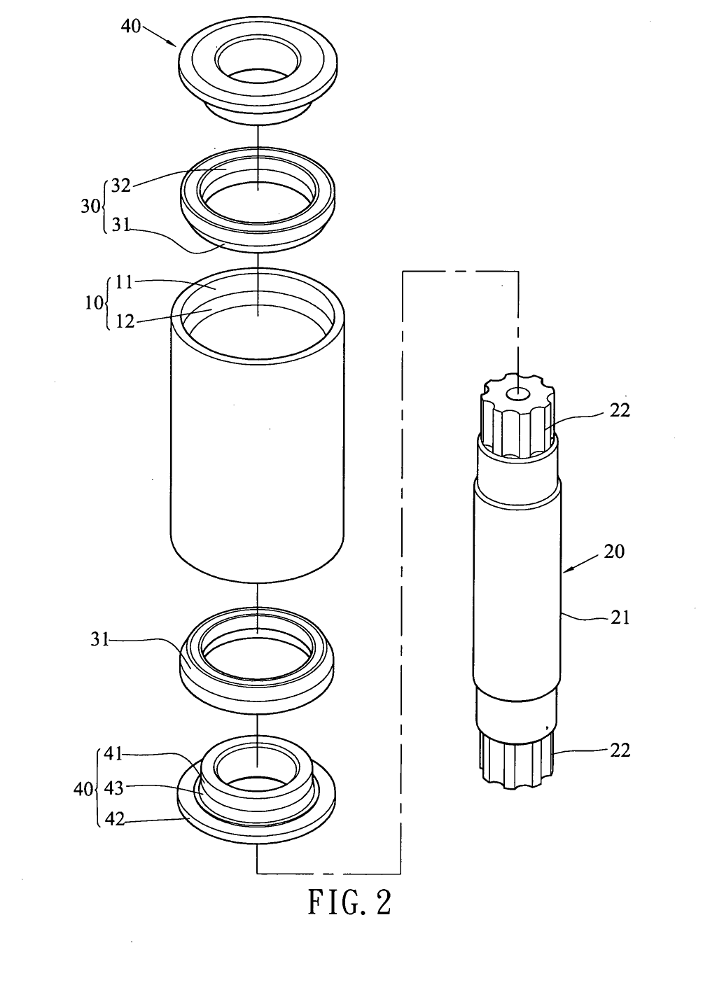

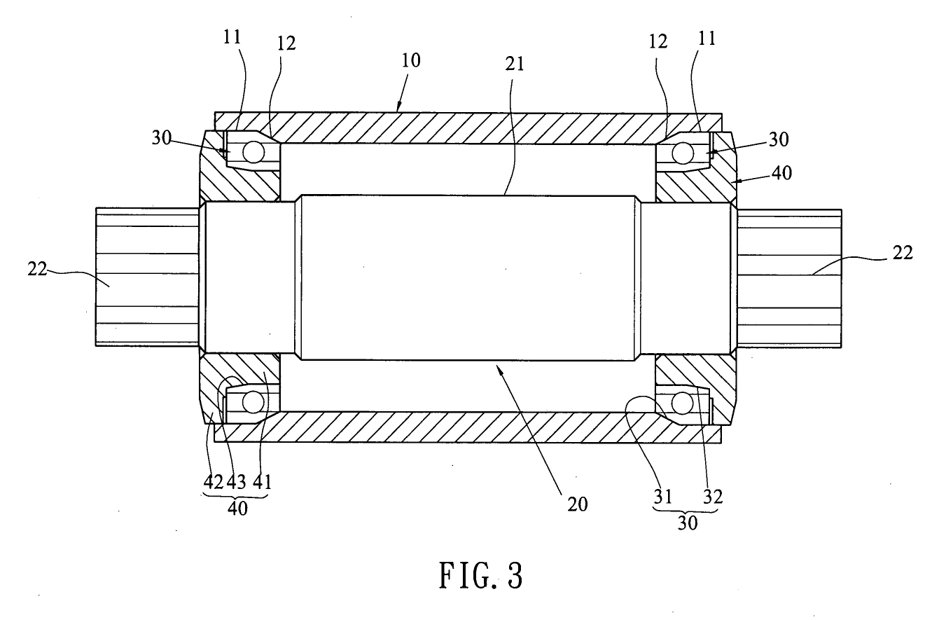

Referring to FIGS. 1 to 3, the bicycle bottom bracket assembly of the present invention comprises a bottom bracket 10 having two open ends 11 and each open end 11 has a plain inner periphery which includes a first tapered inner periphery 12. Two bearings 30 are respectively engaged with the two open ends 11 and each bearing 30 has a first tapered outer periphery 31 which is engaged with the first tapered inner periphery 12 of the bottom bracket 10. Each bearing 30 has a central hole which has a second tapered inner periphery 32.

An axle 20 includes a cylindrical section 21 and two connection ends 22, wherein the two connection ends 22 has a plurality of longitudinal grooves 22 so as to be connected with two cranks which are not shown. The axle 20 extends through the two bearings 30 and two positioning members 40 are mounted to the axle 20. Each positioning member 40 has a second tapered outer periphery 43 which is engaged with the second tapered inner periphery 32 of the bearing 30 corresponding thereto. Each of the two positioning members 40 has an insertion 41 and a flange 42 connected to an end of the insertion 41. The insertion 41 is inserted into the central hole of the bearing 30 and the second tapered outer periphery 43 is defined in an outer periphery of the insertion 41. The positioning members 40 are made by plastic.

When assembling the bottom bracket assembly, the two bearings 30 are first installed in the two open ends 11 of the bottom bracket 10, and the axle 20 extends through the two bearings 30 and the bottom bracket 10. The two positioning members 40 are then mounted to the axle 20 and to position the bearings 30 in position. The assembling processes are simple and easy, so that the bottom bracket assemblies can be assembled within a short period of time.

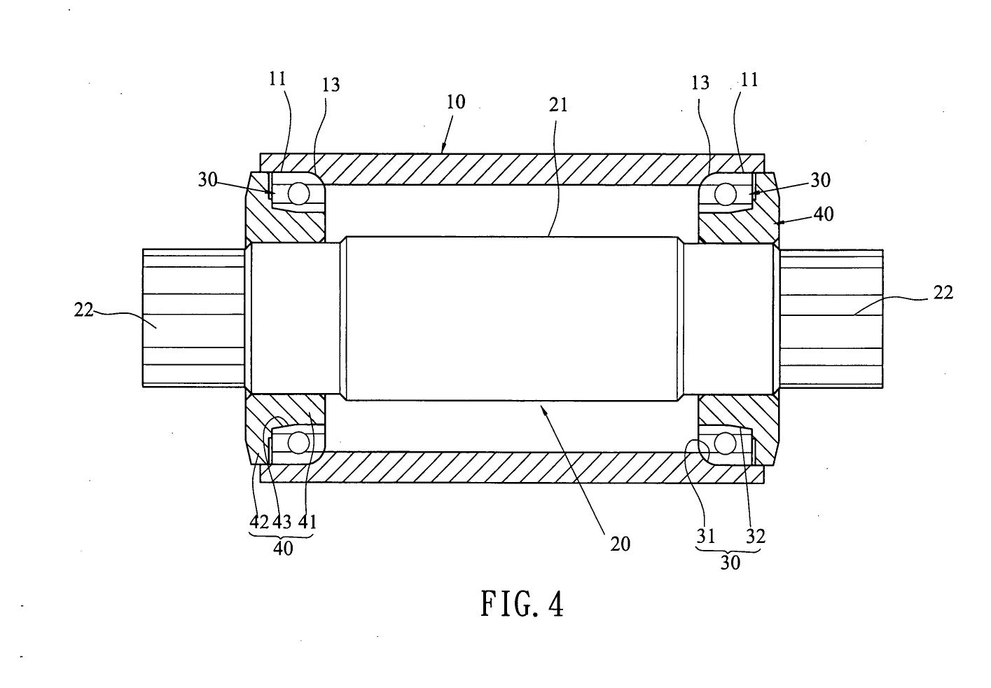

FIG. 4 shows that the first tapered inner periphery 12 can be replaced by a curved groove 13 and the first tapered outer periphery 31 is made to be curved so as to be engaged with the curved groove 13.

While we have shown and described the embodiment in accordance with the present invention, it should be clear to those skilled in the art that further embodiments may be made without departing from the scope of the present invention.

What is claimed is:

1. A bottom bracket assembly for bicycles, comprising:
a bottom bracket having two open ends and each open end having a first tapered inner periphery;
two bearings respectively engaged with the two open ends and each bearing having a first tapered outer periphery which is engaged with the first tapered inner periphery of the bottom bracket, each bearing having a central hole which has a second tapered inner periphery;
an axle extending through the two bearings and having two connection ends, and
two positioning members mounted to the axle and each having a second tapered outer periphery which is engaged with the second tapered inner periphery of the bearing corresponding thereto.

2. The assembly as claimed in claim 1, wherein each of the two open ends of the bottom bracket has a plain inner periphery.

3. The assembly as claimed in claim 1, wherein each of the two positioning members has an insertion and a flange connected to an end of the insertion, the insertion is inserted into the central hole of the bearing and the second tapered outer periphery is defined in an outer periphery of the insertion.

4. The assembly as claimed in claim 1, wherein the positioning members are made by plastic.

5. The assembly as claimed in claim 1, wherein two positioning members each have a passage which is snugly mounted to the axle.

6. The assembly as claimed in claim 1, wherein each of the two connection ends has a plurality of longitudinal grooves.
